(19) United States
(12) Patent Application Publication
(10) Pub. No.: US 2010/0242070 A1
(43) Pub. Date: Sep. 23, 2010

(54) System and method for combining information content from data transmission network with television signal

(75) Inventor: Koji Matsubayashi, San Diego, CA (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Electronics Inc., Park Ridge, NJ (US)

(21) Appl. No.: 12/382,521

(22) Filed: Mar. 18, 2009

(51) Int. Cl. H04N 5/445; H04N 9/74; H04N 7/12

(52) U.S. Cl. 725/61; 348/584; 375/240.25; 348/E09.055; 375/E07.027

(57) ABSTRACT

A system and method for adding information from a data transmission network to a television display includes a first receiver for receiving data signals from a data transmission network, a first signal processor for decoding the data signals and rendering a graphics image based on the data signals in a first area of a frame buffer, a second receiver for receiving television signals, and a second signal processor for decoding the television signals and rendering a video image based on the television signals in a second area of the frame buffer. A display component is provided for mixing the graphics image and the video image from the frame buffer to create a combined image for display on a display device. The data transmission network can be a wireless information network. The graphic image can be a change in the color of wallpaper of the display device.

### BACKGROUND OF THE INVENTION

1. Field of the Invention

This application relates generally to data processing devices for use with televisions, and more particularly to devices for enhancing the information content of television images.

2. Description of the Related Art

The present invention can be used to combine the functions of existing television technologies with existing data transmission networks.

Modern televisions have display devices that are capable of displaying rich graphics and video images. Users can receive content for their televisions from broadcasted television signals, cable service, or satellite service, all of which provide several different channels that may be selected by the user. However, users often must switch between several different TV channels to obtain the information they desire, and are unable to view such information in real time or simultaneously with other televised content, such as entertainment programming.

Data transmission networks are known in the prior art and are capable of transmitting data bearing messages to remotely located radio receivers. For example, the Ambient Information Network is a nationwide wireless network operated by Ambient Devices, Inc. of Cambridge, Mass. This wireless network can be used for sending content over a long-range, bandwidth-constrained, metered-use network. Such networks provide a communication pathway for transmitting data bearing messages that conform to a standard data format simultaneously to many different users. Information transmitted by these networks includes, for example, weather data, financial markets, traffic, personal bank account data, sports, breaking news, and so forth.

Information from existing data transmission networks has been used with wireless technology devices, such as cell phones, portable navigation devices, weather stations, and portable audio/video playback devices. For example, U.S. Patent Publication No. 2007/0250597 by Resner et al. describes a wireless data processing module for use with a portable audio or video player.

While data transmission networks have been helpful in providing information to users of various devices, there remains a need for an improved system for delivering such information content to television users.

### SUMMARY OF THE INVENTION

In accordance with the present invention, a system and method are provided for adding information from a data transmission network to a television display. The system includes a first receiver for receiving data signals from a data transmission network, a first signal processor for decoding the data signals and rendering a graphics image based on the data signals in a first area of a frame buffer, a second receiver for receiving television signals, and a second signal processor for decoding the television signals and rendering a video image based on the television signals in a second area of the frame buffer. A display component is provided for mixing the graphics image and the video image from the frame buffer to create a combined image for display on a display device. The graphics image can be a change in the color of wallpaper of the display device or the like to represent the information content.

The system also has an input device for allowing users to select portions of the data signals to be extracted and rendered as a graphics image in the frame buffer. A symbol converter is used to generate visual content from small packets of information contained in the extracted data signals. The display component mixes the graphics image rendered in the frame buffer with the video images from the television signals so that the visual content of the graphics image overlays the visual content of the television signal to allow the content of the selected data signals to be perceived by a user. The data transmission network can be a wireless information network or other existing networks, such as the Internet.

According to one aspect of the invention, a data processing device is provided, comprising: a first receiver for receiving data signals from a data transmission network; a first signal processor for decoding the data signals and rendering a graphics image based on the data signals in a first area of a frame buffer; a second receiver for receiving video signals from a video signal source; a second signal processor for decoding the video signals and rendering a video image in a second area of the frame buffer; and a display component for mixing the graphics image and the video image from the frame buffer to create a combined image for display on a display device.

According to another aspect of the invention, an interactive system for combining television program content with additional information from a data transmission network is provided, comprising: a first receiver for receiving information bearing signals from a data transmission network; a second receiver for receiving television signals from a television signal source; and a controller responsive to user inputted operating commands for mixing a graphics image rendered from the information bearing signals with a video image rendered from the television signals to create a combined image for display on a display device.

According to another aspect of the invention, a method of enhancing television content with additional information from a data transmission network is provided, the method comprising: receiving information bearing signals from a data transmission network; extracting selected data values from the information bearing signals; processing the selected data values to generate an information signal corresponding to a selected content of the information bearing signals; decoding the information signal and rendering a graphics image corresponding to the information signal in a first area of a frame buffer; rendering a video image corresponding to a television signal in a second area of the frame buffer; and mixing the graphics image and the video image from the frame buffer to create a combined image for display on a display device.

### BRIEF DESCRIPTION OF THE DRAWINGS

These and other more detailed and specific features of the present invention are more fully disclosed in the following specification, reference being had to the accompanying drawings, in which:

FIG. 1 is a schematic overview of a data transmission network used with an interactive system for combining information content from the network with television content in accordance with the present invention.

FIG. 2 is a schematic diagram of a television display having information content combined with television content in accordance with the present invention.

FIG. 3 is a block diagram illustrating the principle hardware components used in an embodiment of the present invention.

FIG. 4 is a flow chart illustrating an embodiment of a method for enhancing television content with additional information content in accordance with the present invention.

FIG. 5 is a flow chart illustrating another embodiment of a method for enhancing television content with additional information content in accordance with the present invention.

### DETAILED DESCRIPTION OF THE INVENTION

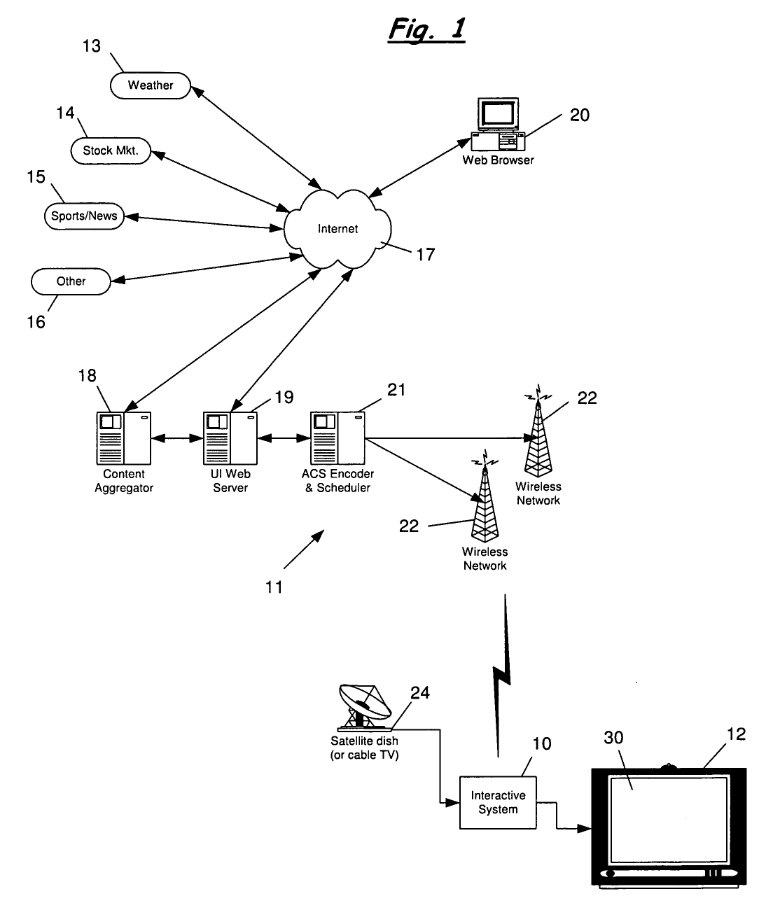

An interactive system 10 and method for combining television programs with additional information from a data transmission network 11 according to the present invention will now be described in detail with reference to FIGS. 1 to 5 of the accompanying drawings.

It should be noted that embodiments of the present invention described herein are illustrated as being used with televisions 12. However, the ordinarily skilled artisan will recognize that other display devices may utilize the method and apparatus of the present invention. Furthermore, in the following description, for purposes of explanation, numerous details are set forth, such as flowcharts and system configurations, in order to provide an understanding of an embodiment of the present invention. However, it will be apparent to one skilled in the art that these specific details are not required in order to practice the present invention.

FIG. 1 illustrates a data transmission network 11 together with an interactive system 10 for combining television program content with additional information from the data transmission network 11. The data transmission network 11 can be a conventional wireless information network as disclosed, for example, in U.S. Patent Publication No. 2007/0250597, which is incorporated herein by reference.

The data transmission network 11 includes information content sources, such as weather sources 13, stock market sources 14, sports/news sources 15, and various other content sources 16. The data from the content sources 13-16 are delivered via the Internet 17 or other suitable means to a content aggregator 18, which provides local server storage for the network 11.

A web server 19 provides an interface for users of the network 11 to customize their information services. A web browser program on a computer 20 connected to the Internet 17 can be used by the user to retrieve web page forms, which are completed by the user and submitted to the web server 19. This interface allows users to remotely configure various aspects of the information service provided by the network 11.

The parameters entered through the web user interface 19, 20 are used by an encoder and scheduler 21 to define the content of wireless packets that are then broadcast by a nationwide network of radio towers 22. The wireless network 11 thus provides a one-way broadcast of the information bearing signals, which can then be received by remote information subscribers.

The interactive system 10 of the present invention can be, for example, a data processing device having an input port 23 that interfaces with a television signal cable 24, and an antenna 27 for interfacing with the data transmission network 11. The antenna 27 provides a first receiver (i.e., a radio receiver) for receiving information bearing wireless data signals from the data transmission network 11. The input port 23 provides a second receiver for receiving a television signal from a TV service such as a terrestrial, cable, or satellite TV service 24. The interactive system 10 creates a modified image for display on a display screen 30 of the television 12.

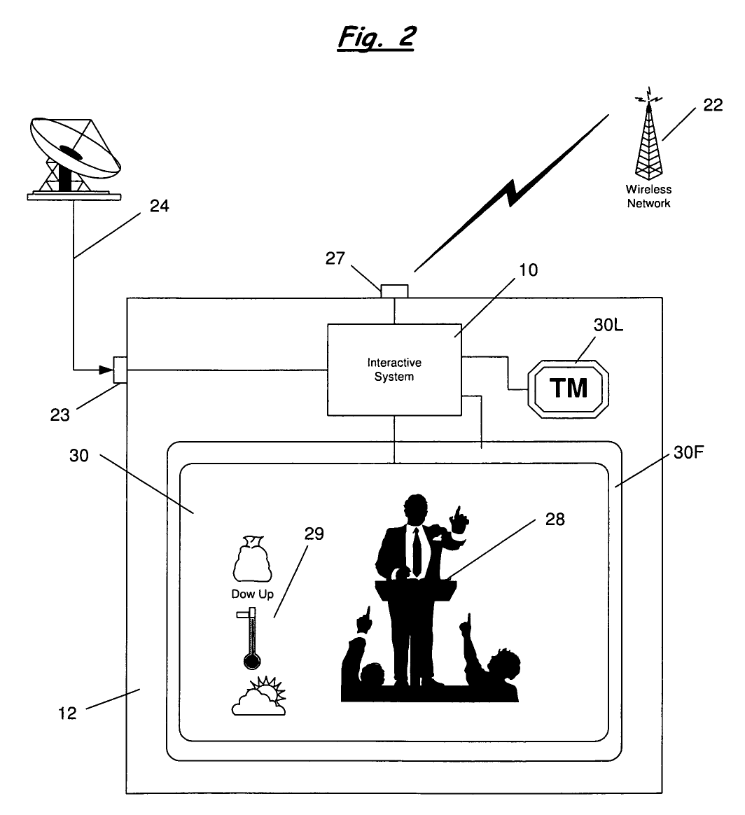

As illustrated in FIG. 2, the modified image includes the normal television content 28 along with additional information content 29. The information content 29 can be made to overlay the television content 28 in a manner that is not offensive or disruptive of the television content 28. For example, the information content 29 can be provided as a graphics image in a corner of the television display 30, or as a tag line at the bottom of the television display 30, or as a change in the color of wallpaper of the television display 30, or as a logo illumination on the display, or the like.

As an alternative, the additional information content may prompt a concurrent visual display with the display screen 30 of the television. This may include illuminating a logo (e.g., manufacturer's logo or other branding), a color of a frame around the display screen, etc. This may be accommodated by driving separate sources of light including but not limited to separate LEDs that offer the possible color changes in the frame, logo, etc.

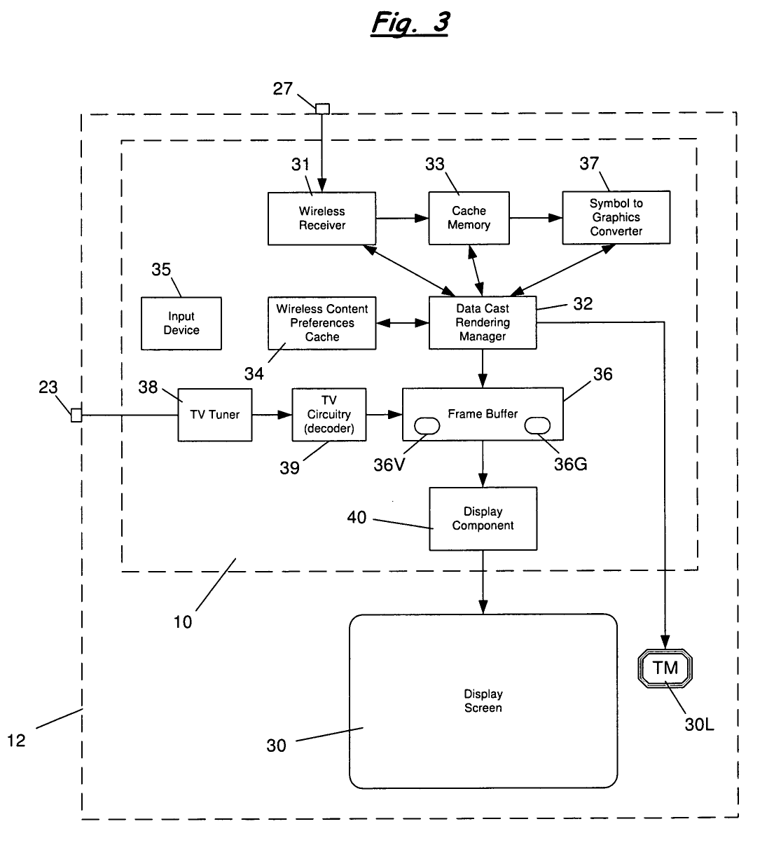

FIG. 3 illustrates an implementation of the system 10 of the present invention in which the information content received from the data transmission network 11 can be combined with a video image rendered from the television signal from the source 24. The system 10 includes the antenna 27, which is attached to a wireless receiver 31 that demodulates and parses the received information signal into a data signal with data values that can be stored and manipulated in the system 10. A data cast rendering manager 32 identifies relevant data and stores the data in a cache memory 33.

The rendering manager 32 follows the instructions in a wireless content preferences cache 34 to determine which incoming content gets cached and which is ignored. The instructions in the content preferences cache 34 are derived from operating commands entered by a user. For example, an input device 35 and/or an on-screen menu can be used to set various user preferences as to which parts of the data signal will be used, as well as how the information content will be rendered by the frame buffer 36 (as further described below).

A symbol-to-graphics converter 37 produces graphics content based on the data stored in the cache memory 33. The symbol converter 37 can produce graphics content by using locally stored images that correspond to the data. For example, a memory unit associated with the symbol converter 37 can be used to store visually displayable blocks of data. The symbol converter 37 can then be used to match the blocks of data with the received data signals. The symbol converter 37 allows rich graphics images to be rendered by the device 10 even though only small packets of information data are received from the network 11.

The data cast rendering manager 32 sends the information content signal produced by the symbol converter 37 to the frame buffer 36, which renders a graphics image based on the data signals in a first area 36G.

At the same time as the graphics images are being rendered in the frame buffer 36, a television signal is received by the tuner 38 and decoded by television circuitry 39. The television signals include video signals that are decoded and rendered in a second area 36V of the frame buffer 36. The television signals can be either standard definition or high definition video formats.

A display component 40 combines the graphic image rendered in area 36G of the buffer memory 36 with the video image rendered in area 36V. The combined image is then displayed on the display screen 30 of the television 12. The combined data and television signal is thus delivered to the display screen 30 of the television 12 in substantially real time immediately after reception of the data signals by the antenna 27.

The display component 40 includes a processor that mixes the rendered images received from the frame buffer 36 according to user-defined parameters. For example, the user can define: (1) the size of the graphics image representing the information content; (2) the particular location of the display where the graphics image 29 representing the information content will overlay the video image 28 representing the television content; (3) whether the graphics image 29 will overlay the video image 28 during regular television programming or only during commercial interruptions; and a variety of other user preferences. The graphics image 29 representing the information content is thus made to be visually perceivable by the user of the television 12.

The system 10 is illustrated as being incorporated into a television 12. However, the system 10 can also be used with other video sources, such as DVD players, VCRs, and the like. In this case, the input port 23 could be arranged to receive a video signal from the video source, and the decoder 39 could be used to decode the video signal for rendering a video image in the frame buffer 36. The graphics image and video image are then combined by the display component 40 for display on the display device 30 in the manner described above.

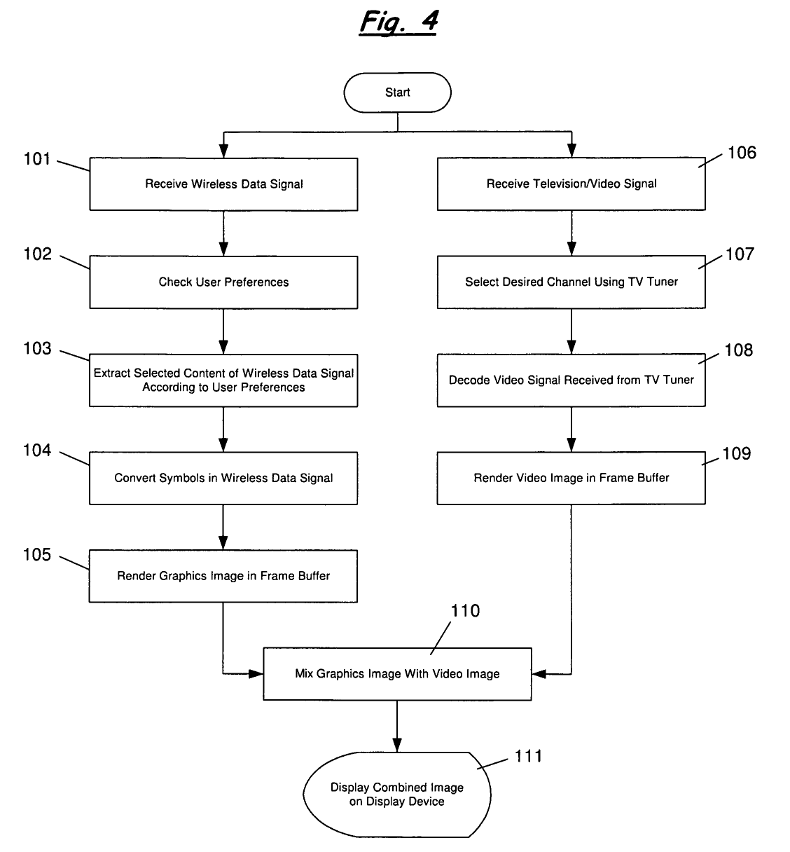

FIG. 4 provides a flow chart illustrating a method for enhancing television content with additional information content in accordance with the present invention. The method starts in step 101 by receiving a wireless data signal from the data transmission network 11. The system 10 allows user preferences to be set, and in step 102 the user preferences are checked to determine which parts of the data signal will be used. In step 103, the data cast rendering manager 32 extracts the selected parts of the data signal according to the user preferences. The symbol-to-graphics converter 37 then converts the packets of data in step 104 to produce the graphics image 29 to be rendered by the system 10. The data cast rendering manager 32 then outputs the graphics image 29 to the frame buffer 36, and the graphics image 29 is rendered in area 36G of the frame buffer 36 in step 105. The graphics image 29 corresponds to the information content of the wireless data signal.

As steps 101 to 105 are being performed, the system 10 is also receiving and processing a television or other video signal in step 106. A desired channel of the television signal is selected by the tuner 38 in a known manner in step 107. The video signal from the selected channel is output from the tuner 38 and decoded in step 108 to produce a video image 28. The video image 28 is then rendered in area 36V of the frame buffer 36 in step 109.

In step 110, the graphics image 29 and the video image 28 are mixed to create a combined image. The combined image is then displayed on the display device in step 111.

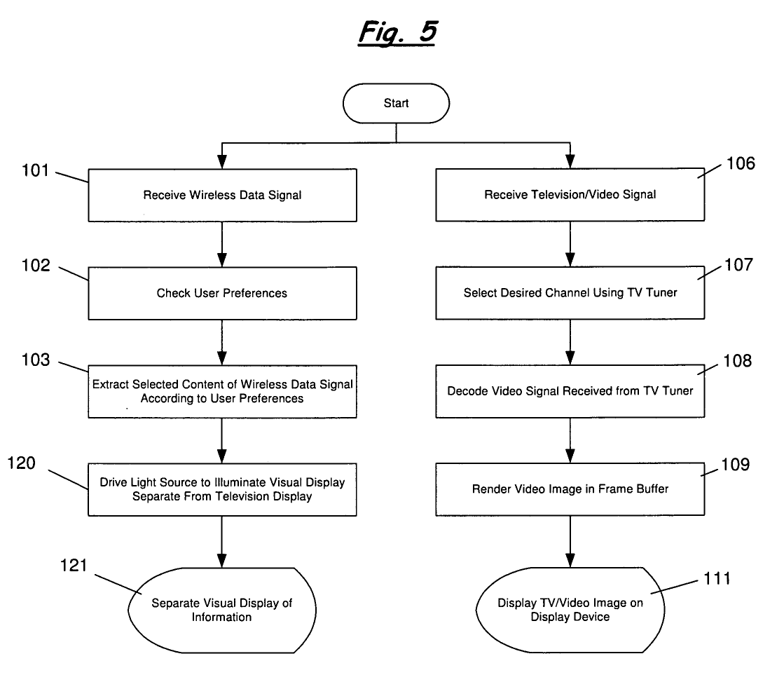

FIG. 5 provides another flow chart illustrating a method for enhancing television content with additional information content in accordance with the present invention. The method steps 101 to 103, 106 to 109 and 111 shown in FIG. 5 are the same as those described above in FIG. 4. The method shown in FIG. 5 differs from the method shown in FIG. 4 because the visual information display created from the wireless data signal is not combined with the video image on the television display. Instead, the visual information display is a concurrent visual display separate from the display screen of the television.

In step 120, a light source is driven to illuminate a visual display, such as a logo 30L or frame 30F around the display screen 30. This provides a separate display in step 121 from the TV/video image displayed in step 111.

Although the present invention has been described in considerable detail with reference to certain embodiments thereof, other embodiments are possible. For example, although the disclosed system 10 includes an on-board television tuner 38 for selecting a TV channel to be combined with the information signal, the system could also be made to work without a television tuner. For example, the system could be made to work with a separate television tuner upstream of the input port 23 of the system 10.

A myriad of other alternatives may also be provided without departing from the scope of the present invention (e.g., different data transmission networks, different user interfaces, and so forth). Other embodiments will become apparent to the ordinarily skilled artisan once instructed according to the present invention. Therefore, the spirit and scope of the appended claims should not be limited to the description of the embodiments contained herein.

What is claimed is:

1. A data processing device, comprising:
a first receiver for receiving data signals from a data transmission network;
a first signal processor for decoding said data signals and rendering a graphics image based on said data signals in a first area of a frame buffer;
a second receiver for receiving video signals from a video signal source;
a second signal processor for decoding said video signals and rendering a video image in a second area of said frame buffer; and
a display component for mixing the graphics image and the video image from the frame buffer to create a combined image for display on a display device.

2. The data processing device according to claim 1, further comprising a controller responsive to operating commands input by a user for controlling said first signal processor to use only a selected portion of said data signals.

3. The data processing device according to claim 1, wherein said second receiver is a television tuner, and said video signals are television signals from said television tuner.

4. The data processing device according to claim 1, wherein said first receiver comprises a radio receiver for receiving data signals from a wireless data transmission network.

5. The data processing device according to claim 1, further comprising a memory for storing said data signals, and wherein said first signal processor retrieves selected data signals stored in said memory.

6. The data processing device according to claim 1, further comprising a memory unit for storing visually displayable blocks of data, and wherein said data signals are used to identify selected blocks of data that are used to render said graphics image.

7. The data processing device according to claim 1, wherein said display component creates the combined image for display in substantially real time upon receiving said data signals.

8. The data processing device according to claim 1, wherein said graphics image comprises a change in color of a wallpaper of the display device.

9. An interactive system for combining television program content with additional information from a data transmission network, said system comprising:
a first receiver for receiving information bearing signals from a data transmission network;
a second receiver for receiving television signals from a television signal source; and
a controller responsive to user inputted operating commands for mixing a graphics image rendered from said information bearing signals with a video image rendered from said television signals to create a combined image for display on a display device.

10. The interactive system according to claim 9, wherein said information bearing signals are transmitted via a wireless data transmission network.

11. The interactive system according to claim 9, wherein said information bearing signals are transmitted via a wireless data transmission network in a one-way broadcast to said first receiver.

12. The interactive system according to claim 9, wherein the content of said information bearing signals is specified by preference values supplied by a user.

13. A method of enhancing television content with additional information from a data transmission network, said method comprising:
receiving information bearing signals from a data transmission network;
extracting selected data values from said information bearing signals;
processing the selected data values to generate an information signal corresponding to a selected content of the information bearing signals;
decoding said information signal and rendering a graphics image corresponding to said information signal in a first area of a frame buffer;
rendering a video image corresponding to a television signal in a second area of said frame buffer; and
mixing the graphics image and the video image from the frame buffer to create a combined image for display on a display device.

14. The method according to claim 13, wherein said step of receiving information bearing signals comprises receiving data signals from a wireless data transmission network.

15. The method according to claim 13, further comprising storing visually displayable blocks of data, and using said information bearing signals to identify selected blocks of data that are used to render said graphics image.

16. The method according to claim 13, wherein said graphics image is mixed with said video image for display in substantially real time upon receiving said information bearing signals.

17. The method according to claim 13, wherein said graphics image comprises a change in color of a wallpaper of the display device.

18. A system for displaying television program content with additional information from a data transmission network, said system comprising:
a first receiver for receiving data signals from a data transmission network;
a first signal processor for decoding said data signals and prompting a visual display based on said data signals;
a second receiver for receiving video signals from a television signal source; and
a second signal processor for decoding said video signals and rendering a video image for display on a display device.

19. The system according to claim 18, wherein said visual display based on said data signals comprises a concurrent visual display separate from the video image on the display device.

20. The system according to claim 18, wherein said visual display based on said data signals comprises a separate source of light from said display device.

21. The system according to claim 19, wherein said visual display comprises a logo illuminated by said separate source of light.

22. The system according to claim 19, wherein said visual display comprises an illuminated frame around a display screen.
